(19) United States
(12) Patent Application Publication
(10) Pub. No.: US 2008/0198215 A1
(43) Pub. Date: Aug. 21, 2008

(54) Printing Device

(75) Inventors: Guido Nopper, Furtwangen (DE); Klaus Stebinger, Brigachtal (DE); Hans-Jurgen Scherzinger, Furtwangen (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: ERNST REINER GMBH & CO. KG FEINMECHANIK UND APPARA, FURTWANGEN (DE)

(21) Appl. No.: 11/817,817

(22) PCT Filed: Mar. 23, 2006
(86) PCT No.: PCT/EP2006/002669

§ 371 Date: Sep. 5, 2007

(30) Foreign Application Priority Data
Mar. 30, 2005 (DE) 102005014227.3

(51) Int. Cl. B41J 3/36

(52) U.S. Cl. 347/109

(57) ABSTRACT

A printing device (1) is provided having a housing (2) and an inkjet printing head (3) which is arranged therein. The printing device is used to print electronically stored data, for example in an internal device memory, on a printing area. The inkjet printing head (3) can be displaced in relation to a printing area in a direction of printing and can be arranged fixed or adjustable in the housing (2) in relation therewith, such that no separate drive is required for advancement thereof. The housing (2) includes a gripping area (4) so that it can be manually held by a user and can be freely displaced during printing at least in a direction of printing for the advancement thereof

### BACKGROUND

The invention relates to a printing device with a housing and an inkjet printing head arranged therein, which is movable in a direction of printing in reference to a printing area to print data, particularly stored electronically in an internal device memory, with the inkjet printing head being arranged in the housing in a rigid or adjustable manner in reference thereto, and the housing being provided with a gripping area to be used manually by a user.

Such a printing device is known from DE 103 53 875 A1. Here, it is necessary for operating the device that a travel detection unit is arranged therein, in order for the control electronics of the previously known printing device to be able to address the printing unit with printing data depending on the advancement. This requires detecting or predetermining a respective advancement on the material to be printed. This is possible according to DE 103 53 875 A1 by a guidance roll, into which a shaft encoder can be integrated as an advancement detection unit. Here, the advancement detection can occur via a slotted wheel coupled to a guidance wheel, which is optically scanned. In this manner, the advancement detection requires the device to be in contact with the printing area. The printing may, however, be primarily in print media or printing areas, which by their consistency can only provide limited resistance to mechanical impingement by a respective pressure to the printing device. For example, foamed material or similarly soft material or loosely suspended paper materials cannot be imprinted with the printing devices of prior art. Uneven surfaces of an object to be printed lead to difficulties as well, because the printing device must be displaced together with the surface to be printed under any circumstances, which leads to a predetermined distance between the printing head and the printing area.

Such a mobile device for printing stamp-like prints is known from DE 201 11 938 U1, which is placed onto the printing area to subsequently print data stored in an internal memory in a stamp-like fashion. Here, the size of the print is precisely defined by the advancement of the printing head inside the printing device.

A manual electric stamping device is described in DE 20 2004 011 038 U1. This manual stamping device is provided with an inkjet printing head having an advancement drive, by which the one or more linear prints can be printed inside a rigidly predetermined printing area, defined by a printing window. The data is stored in the internal device memory, here. For printing, the manual stamping device is placed onto the print medium, which is preferably horizontal, and subsequently the print image, comprising one or more lines, is applied by the inkjet printing head displaced in the direction of printing inside the printing area.

### SUMMARY

Therefore the object is to provide a simple and cost-effective printing device, by which the differently structured materials can be printed as a print media and with the size of the printing area on the print medium being freely selected to a large extent.

In order to attain this object, the invention provides for the printing device to be freely movable together with the housing, at least in the direction of printing, and that the spatial distance of the printing device in reference to the print medium can be selected freely and that the print medium can be printed in a contact-free manner.

The printing device therefore requires no drive for the advancement of the printing head, but it can be held and moved manually, with the movements of the hand of the user holding the printing device in reference to the print medium or the printed area representing the advancement for the inkjet printing head during the printing process. Here, the printing device can be freely moved and guided without contact over the print medium, thus it requires no compression by a guiding wheel or the like to the print medium or any printing area. Rather the distance of the printing device from the print medium can be freely selected or varied within a predetermined distance ranging, for example, from approximately half a millimeter to approximately half a centimeter between the print medium and the printing device, without the quality and thus the clarity or readability of the printed image being essentially compromised. This way even such print media can be printed, in particular, which by their consistency can only provide little resistance to any mechanical impingement. For example, this may apply to foamed materials or similar soft materials or even loosely suspended paper materials. By the free mobility of the printing device in reference to the print medium and the here possible contact-free condition even curved and/or uneven surfaces can be printed with sufficient quality, i.e. with signs being of readable or recognizable quality. The printing device according to the invention, simple with regard to its construction, can be used for the free printing of cardboard, goods made from corrugated cardboard, or for the printing of arbitrary other objects and print areas, thus it has multiple uses, is easily operated, and can be used even under difficult circumstances usually not allowing the application of printing, because the printing device does not need to be pressed to the print medium during operation.

It is advantageous when at least a part of the housing exterior is provided with or forms a gripping area and when the housing can be at least partially be held by hand. The printing device can be manually held and moved and practically used like a writing tool, pencil, or paintbrush.

An alternative embodiment of the invention provides for the handle being provided as a gripping area on the housing. The printing device can thereby be held and moved, for example, similar to a large flashlight or the like, in particular when the circumference of the housing is too large for safe manual holding.

It is beneficial for the ink to be printable onto a print medium outside the housing. It is not necessary for the print medium to be pulled into the housing, as known from inkjet printers of prior art, but the printing device can easily be pointed to the print medium or be placed thereupon and displaced over it in order to apply a print.

A preferred embodiment of the invention may provide that for starting and/or ending the printing process, an acceleration sensor and/or a speed sensor is provided, which registers any change of speed. When starting and stopping the printing process via manual motion of the printing device, the draw or advancement speed may perhaps be insufficient to allow the print of images next to each other so that the first and/or the last lines of data are printed on top of each other partially or entirely. In order to avoid such a problem, the acceleration sensor and/or speed sensor according to the invention causes the printing process to be started only when sufficient advancement is achieved allowing the print of images side-by-side with a safe distance from each other. The printing process in turn is stopped when the predetermined minimum advancement speed is not reached. This can also occur when not all data has been read and printed from the memory in order to avoid the remaining images from being printed on top of each other at the end of the printing process.

An alternative and/or additional way may comprise that for starting and/or stopping the printing process, a manually operated scanner is provided, preferably at the exterior of the housing. Such a scanner is particularly advantageous for a cost-effective design of the printing device, in particular. The above-mentioned problems for starting and ending the printing process can also be attained by the operation of a scanner after the start and/or prior to the end of the manual advancement. Here, experience has shown that for a safe operation of the printing device even a short practicing period is sufficient to achieve printing of all images onto the print medium.

The above-described acceleration sensor can also be combined in an advantageous manner with a manually operated scanner, with the printing device being switched on or activated by the scanner and with the printing process being started/stopped by the acceleration sensor when a sufficiently high/low relative speed of the printing device in reference to the print medium is reached. This combination is particularly advantageous to avoid faulty activation of the printing device, for example by bumps. The scanner can also serve as an on/off switch for the printing device. It is also possible to provide a separate on/off switch arranged at the exterior of the housing, which interrupts the power supply for the entire printing device.

Due to the fact that in the printing device according to the invention the advancement occurs manually by the movement of the entire printing device, in contrast to the known printing devices, and thus a sensor detection of the relative motion of the inkjet printing head in reference to the print medium is not easily possible, it is particularly advantageous when for controlling the width and/or the distance of the image a programmable pulse generator is provided creating a clock, and the number of pulses is equivalent to the printing gaps of the data to be printed.

Advantageously, the mechanical contact of the printing device to the print medium can be omitted because a distance transmitter for the relative movement is replaced by a time-controlled pulse from the pulse generator. The inkjet printing head is here provided with one or more rows of jets, which print the data linearly, with one image comprising several printing lines. According to the clock the images are read linearly from the internal memory (ROM, RAM, or Flash-ROM) and converted by the control electronics via a clock into control signals for the jets of the inkjet printer head. The clock can advantageously be adjusted such that at a mean advancement speed, an easily discernible or legible signal width and line distance develops in the print image.

For starting or stopping the printing process, the clock generator is started and stopped by the acceleration sensor according to the determined positive or negative acceleration of the printing device. For this purpose, a specific analog output voltage of the sensor, proportional in reference to the acceleration of the printing device, is conducted to a start-comparator and a stop comparator, which are fed with a comparison voltage controlled by a controller. When the output voltage of the acceleration sensor reaches the value of the comparison voltage, the output of the start comparator is activated, which starts the clock generator, when previously the start scanner has been activated as well. When the output voltage of the acceleration sensor falls short of the value of the comparison voltage, the output of the stop comparator is activated, which stops the clock generator. By changing the comparison voltage, the trigger sensitivity of the printing device can easily be adjusted. It is advantageous when the comparison voltages of both comparators can be adjusted independent from each other so that the trigger sensitivity and the termination sensitivity can be adjusted independent from each other.

In order to allow a comfortable and easy creation and change of the data that is to be printed, it is useful for the printing device to have a data interface coupling it to a PC or a similar control device. For this purpose, the PC is provided with software, by which the data can be appropriately processed prior to the transmission to the printing device. Using this software it is also possible to adjust the operating parameters of the printing device, for example to adjust the clock or an initial delay of the printing process, when controlling the clock via the acceleration sensor.

Here, it is advantageous for the data that can be printed to be provided as consecutive data blocks, for data blocks to be predetermined data and/or freely defined data and for the data preferably being letters and/or symbols. These freely defined or predetermined data blocks can be easily and comfortably composed at the PC with the aid of software. Here, for example date and/or time statements, defined counters or numbers or the like may be selected as the predetermined data blocks. The initial value of the counter and/or the type of numbering can be freely selected. Date and time can be provided by the PC. Here, the PC provides an initial value for the internal time piece located in the printing device, which automatically forwards the values for date and time after the decoupling from the PC. Here, a switch from daylight savings time to standard time or similar special occasions can also be considered by the internal time piece. The freely defined data may be letters, numbers, or symbols, with freely defined symbolic signs, for example company signs, and mirror reflections of certifications or the like are also possible. Subsequently a sequence of the data blocks can be set, in order to then transfer this sequence of data blocks as print data to the printing device. When sequencing the data blocks, it is possible to define a certain number of blank blocks at a certain position, in order to achieve a pause during the printing process. Said pause can be used to displace the printing device to a different location on the print medium. For example, this way not only the preferred one-line print can be adjusted but also allows the creation of two or more lines, in particular underneath of each other. During the printing pause, either a mere displacement of the printing device can occur and/or the printing process can be interrupted for a longer period of time by activating the start scanner.

For a simple coupling of the printing device to the PC, it is useful for the data to be transferred between the data interface of the printing device and the PC with the help of a data transmission cable or via wireless data transmission. Such data interfaces are known and available in multiple types, preferably a USB-interface being provided at the printing device according to the invention.

The printing process can occur after or during the data transmission, i.e. online or offline. In the online operation, a cable connection (e.g. via USB) or a wireless connection (e.g., via Bluetooth) to the control device can be used. In the offline operation the printing process starts only after the end of the data transmission and the disconnection from the control device.

A preferred embodiment of the printing device according to the invention provides for the printing device being provided with at least one accumulator or a battery for supplying energy, and that the accumulator is rechargeable via a data interface, in particular. This way, a preferred mobile, in particular wireless use of the printing device is possible, which also supports the free mobility of the printing device during the printing process in an advantageous manner. The preferred USB interface, being the data interface, can provide the charging power for the accumulator in a manner known per se, resulting in a particularly easy operation of the printing device, because for example, the charging of the accumulator and the transmission of data can at least partially occur simultaneously. This way an additional power supply connection to the housing can also be omitted. Preferably the accumulators are of a standard size, for example AA or AAA for a simple and cost-effective replacement.

It is particularly advantageous when for the protection of the inkjet printing head, a preferably ink-tight closing cap is provided during off times. In particular with a movable use of the printing device, during longer pauses between printing processes, such a protective cap can protect the inkjet printing head not only from damage but also effectively from drying up. Furthermore, accidental leaking of ink can be avoided.

In order to allow replacement of a defective inkjet printing head, it is beneficial for the inkjet printing head to be exchangeable and in particular arranged in a housing part detachable from the housing. In this manner, an exchange of various embodiments of inkjet printing heads is possible depending on their purpose for use. For example, the printable amount of ink can be varied by differently sized inkjets or the print resolution by the number of inkjets.

In order to control the data transmitted into the printing device it is advantageous for the printing device to be provided with a display element, on which at least the data stored in the internal memory can be displayed. In particular in a movable use and/or when several printing devices are used with different content in the device memory, such a display element can be advantageous. The display element can show, in addition to the data stored in the internal device memory, for example, also the date and time statements provided by the time piece, in particular permanently.

Here, it can be beneficial for the printing device to be provided with an input device for entering new data and/or changing existing data in the internal device memory. For example a miniaturized keyboard can be provided, to be operated with a stylus or the like, by which at least the sequence of the data blocks can be changed or certain data blocks can be deleted from the device memory. Here, the display of the operating steps can occur, on the one hand, on the display element and, on the other hand, additionally by acoustic signals.

For a secure operation of the printing device it is particularly advantageous for the printing device to be provided with a distance sensor for measuring a distance between the printing device and the print medium. For example, the distance sensor can control the amount of ink ejected through the inkjets or trigger an acoustic and/or optic warning signal when the printing device is not moved within the preferred range of distance of the print medium from the printing device.

During the printing process the printing device can be moved to change a longitudinal extension of a signal sequence to be printed onto the print medium in the direction of printing at different speeds or to create a non-linear progression of the print signal sequence, in particular in an arched shape, wavy, or similar non-linear fashion. This way, the printing range can not only be changed depending on the existing print medium, but in particular prints are possible not creatable by prior printers that print only straight, linear lines. The printing device can therefore be used in many different fields in a very flexible manner.

Additionally, to create cursive signs the printing device or the inkjet printing head is beneficially rotational in reference to the print media around its longitudinal axis extending perpendicular to a direction of printing, in particular around an angle ranging from approximately 0° to approximately 45°.

For creating print in normal reading direction, it is beneficial for the printing device to be mobile in the reading direction of the printed data, in particular from the left to the right. Here, the signs are printed in consecutive lines from the left to the right, as already mentioned.

However, the printing device can also be moved opposite the normal reading direction, in particular from the right to the left, to create mirror-reflected writing. Here, the creation of writings is possible, for example, in which the reading direction extends from the right to the left. Similarly in a travel direction from the top to the bottom writing can be printed with the respective reading direction. The creation of writing upside-down is possible by the printing device being rotated 180° and moved from the right to the left.

It is advantageous for a preferably exchangeable and/or removable stamping device to be provided at the printing device and for the stamping device to be arranged at an end of the housing facing away from the inkjet printer head, in particular. This stamping device may comprise, in addition to the device memory of the printing device, additional defined, predetermined data. This may for example be a user-specific signature, a company sign, or the like. For example, the stamp arrangement can here be arranged at the end of the printing device facing away from the inkjet printer head, in particular be plugged on. In the normal position the stamping device can be plugged on such that a stamping plate points in the direction of the housing of the printing device or is arranged therein and thus is protected. For the stamping process the stamping device can be detached from the printing device, particularly with the help of at least one stamp gripping element, and can be reattached to the printing device in the stamping position, with in this stamping position the stamping plate now being aligned upside-down, facing away from the housing of the printing device. This way the printing device can simply be rotated by approximately 180° and prior or after the printing a stamp image can be created on the print medium.

The stamping device can be removed from the printing device and be replaced by a stamping device, for example having a differently designed stamp arrangement. The stamp arrangement can here also be a personally, user-specific coding element, with it being possible that in case of a stamping device missing from the printing device the printing device being blocked electronically and/or mechanically and no printing can occur. When a stamping device is plugged on the blocking is released and the printing device is operational. Here, it is also possible, in addition to the blockage, also to transmit personal identification data from the stamping device to the printing device, so that only a certain stamping device can unlock a certain corresponding printing device.

An alternative embodiment may provide for the stamping device to be plugged onto the inkjet printing head for stamping. The stamping device can here be removed from its neutral position at the housing side facing away from the inkjet printing head and be plugged onto the inkjet printing head so that no rotation of the printing head is necessary for stamping.

The stamping device is provided with a storage container forming the ink reservoir, arranged preferably above the stamping plate or the like neighboring it, saturated with ink and filled with an absorbent material. The storage container may be provided with small apertures for a refill, into which for example a pipette or the like can be inserted for refilling ink. It is advantageous for the storage container to be provided with a basic corpus made from micro-porous material and largely covered by a sheet, and for the sheet to be provided at the bottom of the storage container with penetrations according to the stamp image, forming the stamping plate. Using this simple design with a thin sheet cover, the basic corpus can practically be used over the entire volume of the storage container for storing ink so that this way even a size or weight reduced design of the entire manual stamping device can be achieved. Due to its low thickness and its high flexibility the sheet hinders the compression of the basic body during the stamping process only a negligible extent.

An alternative embodiment may provide for the ink reservoir to be an inkpad saturated with ink or the like impinging a stamping plate in the neutral position. The inkpad can here be arranged, for example, in a lid, which in the neutral position of the stamping device can be folded over the stamping plate and thus, on the one hand, applies ink onto the stamping plate and, on the other hand, simultaneously provides protection of the stamping plate from damage and contamination.

### BRIEF DESCRIPTION OF THE DRAWINGS

In the following an exemplary embodiment of the invention is described in greater detail using the drawing. It shows in a partially schematic illustration:

FIG. 1 a lateral, slightly enlarged view of a printing device according to the invention in the printing position, however without the hand holding and guiding it, at the spatial distance according to the invention in reference to a print medium, which can be printed touchlessly with this printing device,

FIG. 2 a view of the printing device diagonally from the bottom with a view of a cover of the inkjet printing head arranged on an exchangeable housing part,

FIG. 3 a partially longitudinal cross-sectional view of the printing device,

FIG. 4 a perspective view of a stamping device removed from the printing device,

FIG. 5 a cross-sectional view of the stamping device in the neutral position at the end of the printing device facing away from the inkjet printing head, and

FIG. 6 a cross-sectional view of the stamping device in the stamping position at the end of the printing device facing away from the inkjet printing head.

### DETAILED DESCRIPTION OF THE PREFERRED EMBODIMENTS

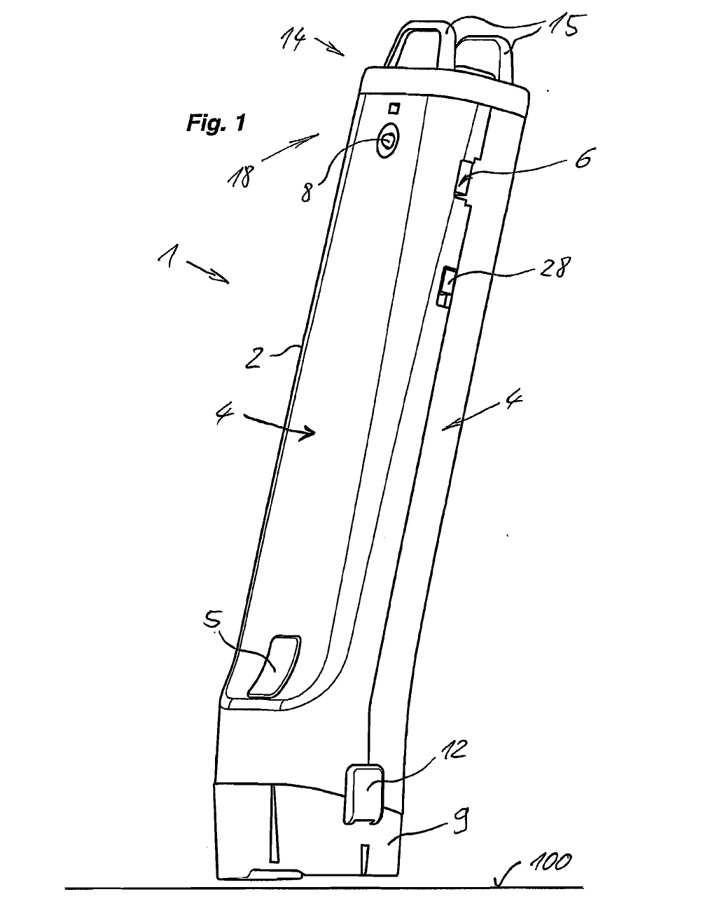

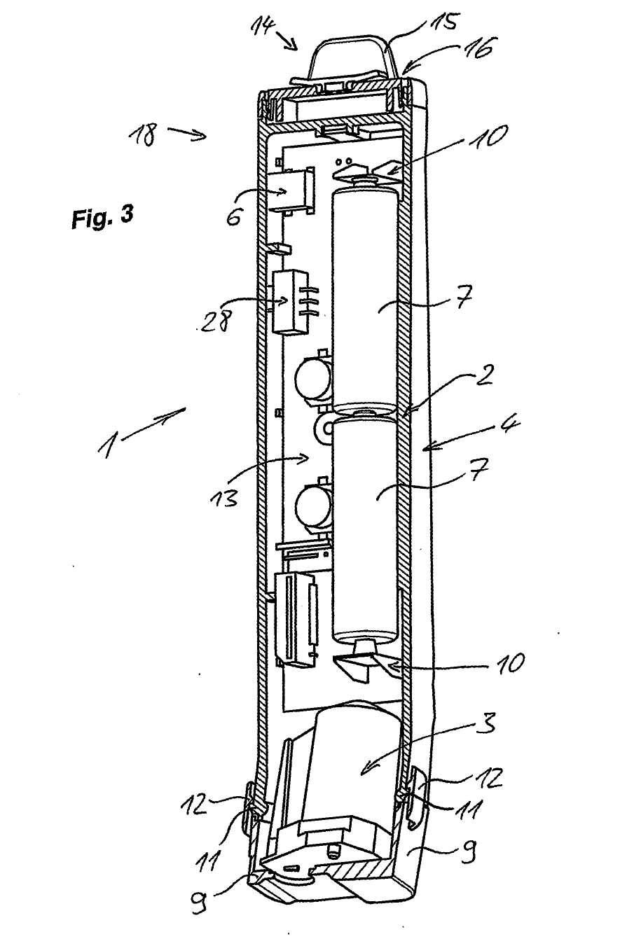

A printing device, in its entirety marked 1 and discernible in FIGS. 1 through 3, has a housing 2 and an inkjet printing head 3 (FIG. 3), which is arranged in the housing 2 fixed or non-adjustable in reference thereto. At the housing 2 a gripping area 4 is provided for a user manually holding it, in order to allow the printing device 1 to be moved in the direction of printing for printing the data stored electronically in the internal memory to a print area mobile in reference thereto, so that during printing the inkjet printing head 3 is displaced together with the printing device 1 in the direction of printing.

The gripping area 4 is here formed by the exterior of the housing 1, as shown in FIG. 1. the housing 1 preferably has dimensions from approximately 15 to 20 centimeters, for example 17 centimeters in length, approximately 2 to 5 centimeters, for example 3 centimeters in width, and approximately 2 to 5 centimeters, for example 3 centimeters in depth, thus the housing 1 can easily be held with one hand and can practically be moved like a writing pen. This is advantageous, in particular, for easily and quickly learning the operation of the printing device 1 in order to give the user a writing feeling as realistic as possible. Here, smaller dimensions of the housing are also possible in order to assimilate the exterior shape of the printing device 1 even more to that of a writing pen. As discernible in the figures, the gripping area 4 is largely smooth, embodied without any larger uneven sections or protrusions, in order to facilitate even an extended manual holding of the printing device 1.

In order to start and finish the printing process, an acceleration and/or speed sensor is provided, not shown in greater detail, and/or as discernible from FIG. 1, a manually operated scanner 5 is arranged at the exterior of the housing 2. The scanner 5 is here advantageously operated by one finger, preferably the index finger of the hand holding the housing 2. This way the printing device 1 can be moved with the desired advancement speed over a print medium 100, and during said movement the scanner 5 can be operated so that particularly during the start of the printing process a printing of images over top of each other due to the advancement speed being too slow can be avoided.

A data interface 6 is provided for transmitting electronic print data from a PC or a similar control device to the internal device memory of the printing device 1. The data interface 6 can here be either embodied as a plug connection for a cable, for example via USB, or wireless in form of a radio or infrared connection. In the preferred embodiment shown in FIG. 1, the data interface 6 is a USB interface. The printing device 1 is provided with batteries or accumulators 7 as an internal power supply, in particular for a mobile use, discernible in FIG. 3 and advantageously being rechargeable via a recharging current from the USB interface 6 while coupled to the PC. The batteries 7 are held in the receptacle 10 known per se.

In FIG. 3, neighboring the two batteries 7, a circuit board 13 of the internal electronics of the printing device 1 is discernible in a schematic illustration, on which in addition to the on/off switch 28 and the data interface 6 the internal device memory, not shown in greater detail, is arranged as well as a control device, not shown in greater detail.

In FIGS. 1 and 3, the on/off switch 28 is discernible, which is embodied as a slide switch arranged at the exterior of the housing 2 and switching on/off the power supply of the printing device. This way, when the printing device 1 is not in use, all electronics can be switched off in order to extend the life of the batteries 7 by this energy saving measure.

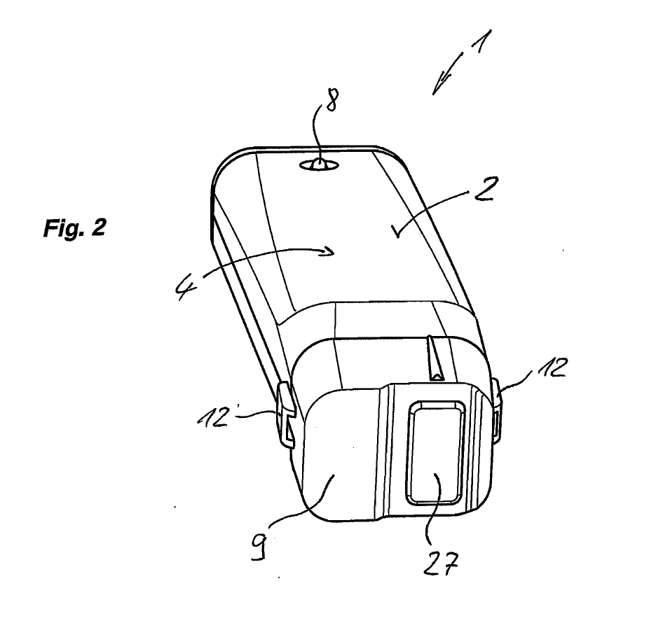

An operating light 8 is provided at the exterior of the housing 2, which is discernible in FIGS. 1 and 2, and which can also indicate in addition to the operational state, for example, the charging state or similar operating parameters of the printing device 1, for example by blinking differently and/or different signal colors.

In FIGS. 1 through 3 it is discernible that the inkjet printing head 3 is arranged in a housing part 9 that is detachable from the housing 2. In this manner, the inkjet printing head 3 is exchangeable, which allows an easy replacement in case of a defect or an exchange of the type of inkjet printing head. The housing part 9 is held to the housing 2 via a snap connection, formed by two opposite snapping latches 11 arranged at the housing 2, which in the assembled state of the inkjet printing head 3 are each engaged with a snapping latch 12 at the housing part 9.

According to FIG. 2, a covering closing cap 27 is plugged onto the inkjet printing head 3, which can protect the inkjet printing head 3 from damage and primarily from an unintended ink emission when the printing device 1 is not in use. The closing cap 27 can be detached or folded away with the help of a hinge, not shown in greater detail, in order to uncover the inkjet printing head 3 in the printing position.

For a simplified operation and an improved ergonomic condition of the printing device 1 it is advantageous when, as indicated in FIGS. 1 and 3, the housing part 9 with the inkjet printing head 3 is arranged at a slight angle in reference to the housing 2. Thus the printing device 1, similar to a writing pen, can be held at an angle smaller than 90°, however, the inkjet of the inkjet printing head 3 are preferably positioned perpendicular in reference to the print medium 100. The longitudinal axis of the housing part 9 can here be preferably 5° to 15° in reference to the longitudinal axis of the housing 2.

In order to apply images, symbols, or the like, in particular those larger than one line height of the inkjet printing head 3 or impossible to be processed by the internal electronic of the printing head 1, a stamping device 14 is provided on the printing device 1, which is discernible in FIGS. 1 and 3 at the printing device 1. The stamping device 14 is detachable from the printing device 1 and, at least in the normal position, arranged at the end of the printing device 1 facing away from the inkjet printing head 3.s

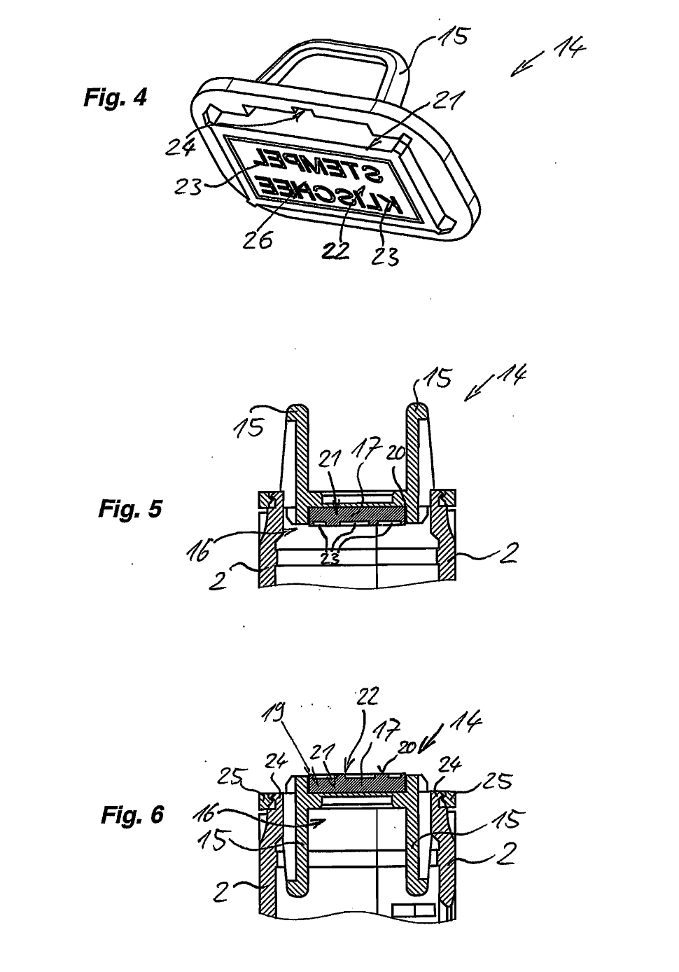

The stamping device 14 is provided with two stamp holding elements 15 discernible in FIGS. 1, 3, 4, 5, and 6, by which the stamp device 14 can be detached from the receptacle 16 at the stamping end 18 of the printing device 1 facing away from the inkjet printing head 3, rotated by approximately 180°, and in this stamping position it can be plugged back into said receptacle 16. FIG. 5 shows in a cross-section the normal position of the stamping device 14 with a stamping plate 17 facing inwardly in reference to the housing 2 of the printing device 1, FIG. 6 however shows the stamping position of the stamping device 14 at the stamping end 18 of the printing device 1 with the stamping plate 17 facing outwardly, away from the stamping end 18 of the printing device 1. In the stamping position the printing device 1 is rotated by 180° in reference to the printing position for stamping, and the printing plate 17 with the stamping image 26, arranged at the stamping end 18, is pressed onto the print medium 100.

As discernible from FIGS. 5 and 6, the stamping device 14 is provided with at least two stamp snapping latches 24 for a detachable fastening at the housing 2, each of which engage a housing snapping latch 25 of the housing 2. Here, the stamp snapping latches 24 and the housing snapping latches 25 each are embodied symmetrically such that a detachable fastening is given in the normal position and also in the stamping position of the stamp device 14.

The stamping device 14 is provided, as discernible in FIGS. 5 and 6, with a storage device 19 made from a saturated absorbent material filled with ink as an ink reservoir, arranged in the normal position on top of the stamping plate 17. The storage device 19 has a basic body 21 made from a micro-porous material enwrapped by a sheet 20, which at its upper side 22 has apertures 23 according to the stamp image 26 and thus forms the stamping plate 17.

A printing device 1 with a housing 2 and an inkjet printing head 3 arranged therein serves to print data to a print area, for example electronically stored in an internal data memory. The inkjet printing head 3 is mobile in reference thereto in a direction of printing and arranged in the housing 2 fixed or non-adjustable in reference thereto so that no separate drive is necessary for its advancement. The housing 2 is provided with a gripping area 4 to be held manually by a user and at least in the direction of printing it is freely mobile for creating the advancement during printing.

The invention relates to a printing device with a housing and an inkjet printing head arranged therein, which is movable in a direction of printing in reference to a printing area to print data, particularly stored electronically in an internal device memory, with the inkjet printing head being arranged in the housing in a rigid or adjustable manner in reference thereto, and the housing being provided with a gripping area to be used manually by a user.

Such a printing device is known from DE 103 53 875 A1. Here, it is necessary for operating the device that a travel detection unit is arranged therein, in order for the control electronics of the previously known printing device to be able to address the printing unit with printing data depending on the advancement. This requires detecting or predetermining a respective advancement on the material to be printed. This is possible according to DE 103 53 875 A1 by a guidance roll, into which a shaft encoder can be integrated as an advancement detection unit. Here, the advancement detection can occur via a slotted wheel coupled to a guidance wheel, which is optically scanned. In this manner, the advancement detection requires the device to be in contact with the printing area. The printing may, however, be primarily in print media or printing areas, which by their consistency can only provide limited resistance to mechanical impingement by a respective pressure to the printing device. For example, foamed material or similarly soft material or loosely suspended paper materials cannot be imprinted with the printing devices of prior art. Uneven surfaces of an object to be printed lead to difficulties as well, because the printing device must be displaced together with the surface to be printed under any circumstances, which leads to a predetermined distance between the printing head and the printing area.

Such a mobile device for printing stamp-like prints is known from DE 201 11 938 U1, which is placed onto the printing area to subsequently print data stored in an internal memory in a stamp-like fashion. Here, the size of the print is precisely defined by the advancement of the printing head inside the printing device.

A manual electric stamping device is described in DE 20 2004 011 038 U1. This manual stamping device is provided with an inkjet printing head having an advancement drive, by which the one or more linear prints can be printed inside a rigidly predetermined printing area, defined by a printing window. The data is stored in the internal device memory, here. For printing, the manual stamping device is placed onto the print medium, which is preferably horizontal, and subsequently the print image, comprising one or more lines, is applied by the inkjet printing head displaced in the direction of printing inside the printing area.

Therefore the object is to provide a simple and cost-effective printing device, by which the differently structured materials can be printed as a print media and with the size of the printing area on the print medium being freely selected to a large extent.

In order to attain this object, the invention provides for the printing device to be freely movable together with the housing, at least in the direction of printing, and that the spatial distance of the printing device in reference to the print medium can be selected freely and that the print medium can be printed in a contact-free manner.

The printing device therefore requires no drive for the advancement of the printing head, but it can be held and moved manually, with the movements of the hand of the user holding the printing device in reference to the print medium or the printed area representing the advancement for the inkjet printing head during the printing process. Here, the printing device can be freely moved and guided without contact over the print medium, thus it requires no compression by a guiding wheel or the like to the print medium or any printing area. Rather the distance of the printing device from the print medium can be freely selected or varied within a predetermined distance ranging, for example, from approximately half a millimeter to approximately half a centimeter between the print medium and the printing device, without the quality and thus the clarity or readability of the printed image being essentially compromised. This way even such print media can be printed, in particular, which by their consistency can only provide little resistance to any mechanical impingement. For example, this may apply to foamed materials or similar soft materials or even loosely suspended paper materials. By the free mobility of the printing device in reference to the print medium and the here possible contact-free condition even curved and/or uneven surfaces can be printed with sufficient quality, i.e. with signs being of readable or recognizable quality. The printing device according to the invention, simple with regard to its construction, can be used for the free printing of cardboard, goods made from corrugated cardboard, or for the printing of arbitrary other objects and print areas, thus it has multiple uses, is easily operated, and can be used even under difficult circumstances usually not allowing the application of printing, because the printing device does not need to be pressed to the print medium during operation.

It is advantageous when at least a part of the housing exterior is provided with or forms a gripping area and when the housing can be at least partially be held by hand. The printing device can be manually held and moved and practically used like a writing tool, pencil, or paintbrush.

An alternative embodiment of the invention provides for the handle being provided as a gripping area on the housing. The printing device can thereby be held and moved, for example, similar to a large flashlight or the like, in particular when the circumference of the housing is too large for safe manual holding.

It is beneficial for the ink to be printable onto a print medium outside the housing. It is not necessary for the print medium to be pulled into the housing, as known from inkjet printers of prior art, but the printing device can easily be pointed to the print medium or be placed thereupon and displaced over it in order to apply a print.

A preferred embodiment of the invention may provide that for starting and/or ending the printing process, an acceleration sensor and/or a speed sensor is provided, which registers any change of speed. When starting and stopping the printing process via manual motion of the printing device, the draw or advancement speed may perhaps be insufficient to allow the print of images next to each other so that the first and/or the last lines of data are printed on top of each other partially or entirely. In order to avoid such a problem, the acceleration sensor and/or speed sensor according to the invention causes the printing process to be started only when sufficient advancement is achieved allowing the print of images side-by-side with a safe distance from each other. The printing process in turn is stopped when the predetermined minimum advancement speed is not reached. This can also occur when not all data has been read and printed from the memory in order to avoid the remaining images from being printed on top of each other at the end of the printing process.

An alternative and/or additional way may comprise that for starting and/or stopping the printing process, a manually operated scanner is provided, preferably at the exterior of the housing. Such a scanner is particularly advantageous for a cost-effective design of the printing device, in particular. The above-mentioned problems for starting and ending the printing process can also be attained by the operation of a scanner after the start and/or prior to the end of the manual advancement. Here, experience has shown that for a safe operation of the printing device even a short practicing period is sufficient to achieve printing of all images onto the print medium.

The above-described acceleration sensor can also be combined in an advantageous manner with a manually operated scanner, with the printing device being switched on or activated by the scanner and with the printing process being started/stopped by the acceleration sensor when a sufficiently high/low relative speed of the printing device in reference to the print medium is reached. This combination is particularly advantageous to avoid faulty activation of the printing device, for example by bumps. The scanner can also serve as an on/off switch for the printing device. It is also possible to provide a separate on/off switch arranged at the exterior of the housing, which interrupts the power supply for the entire printing device.

Due to the fact that in the printing device according to the invention the advancement occurs manually by the movement of the entire printing device, in contrast to the known printing devices, and thus a sensor detection of the relative motion of the inkjet printing head in reference to the print medium is not easily possible, it is particularly advantageous when for controlling the width and/or the distance of the image a programmable pulse generator is provided creating a clock, and the number of pulses is equivalent to the printing gaps of the data to be printed.

Advantageously, the mechanical contact of the printing device to the print medium can be omitted because a distance transmitter for the relative movement is replaced by a time-controlled pulse from the pulse generator. The inkjet printing head is here provided with one or more rows of jets, which print the data linearly, with one image comprising several printing lines. According to the clock the images are read linearly from the internal memory (ROM, RAM, or Flash-ROM) and converted by the control electronics via a clock into control signals for the jets of the inkjet printer head. The clock can advantageously be adjusted such that at a mean advancement speed, an easily discernible or legible signal width and line distance develops in the print image.

For starting or stopping the printing process, the clock generator is started and stopped by the acceleration sensor according to the determined positive or negative acceleration of the printing device. For this purpose, a specific analog output voltage of the sensor, proportional in reference to the acceleration of the printing device, is conducted to a start-comparator and a stop comparator, which are fed with a comparison voltage controlled by a controller. When the output voltage of the acceleration sensor reaches the value of the comparison voltage, the output of the start comparator is activated, which starts the clock generator, when previously the start scanner has been activated as well. When the output voltage of the acceleration sensor falls short of the value of the comparison voltage, the output of the stop comparator is activated, which stops the clock generator. By changing the comparison voltage, the trigger sensitivity of the printing device can easily be adjusted. It is advantageous when the comparison voltages of both comparators can be adjusted independent from each other so that the trigger sensitivity and the termination sensitivity can be adjusted independent from each other.

In order to allow a comfortable and easy creation and change of the data that is to be printed, it is useful for the printing device to have a data interface coupling it to a PC or a similar control device. For this purpose, the PC is provided with software, by which the data can be appropriately processed prior to the transmission to the printing device. Using this software it is also possible to adjust the operating parameters of the printing device, for example to adjust the clock or an initial delay of the printing process, when controlling the clock via the acceleration sensor.

Here, it is advantageous for the data that can be printed to be provided as consecutive data blocks, for data blocks to be predetermined data and/or freely defined data and for the data preferably being letters and/or symbols. These freely defined or predetermined data blocks can be easily and comfortably composed at the PC with the aid of software. Here, for example date and/or time statements, defined counters or numbers or the like may be selected as the predetermined data blocks. The initial value of the counter and/or the type of numbering can be freely selected. Date and time can be provided by the PC. Here, the PC provides an initial value for the internal time piece located in the printing device, which automatically forwards the values for date and time after the decoupling from the PC. Here, a switch from daylight savings time to standard time or similar special occasions can also be considered by the internal time piece. The freely defined data may be letters, numbers, or symbols, with freely defined symbolic signs, for example company signs, and mirror reflections of certifications or the like are also possible. Subsequently a sequence of the data blocks can be set, in order to then transfer this sequence of data blocks as print data to the printing device. When sequencing the data blocks, it is possible to define a certain number of blank blocks at a certain position, in order to achieve a pause during the printing process. Said pause can be used to displace the printing device to a different location on the print medium. For example, this way not only the preferred one-line print can be adjusted but also allows the creation of two or more lines, in particular underneath of each other. During the printing pause, either a mere displacement of the printing device can occur and/or the printing process can be interrupted for a longer period of time by activating the start scanner.

For a simple coupling of the printing device to the PC, it is useful for the data to be transferred between the data interface of the printing device and the PC with the help of a data transmission cable or via wireless data transmission. Such data interfaces are known and available in multiple types, preferably a USB-interface being provided at the printing device according to the invention.

The printing process can occur after or during the data transmission, i.e. online or offline. In the online operation, a cable connection (e.g. via USB) or a wireless connection (e.g., via Bluetooth) to the control device can be used. In the offline operation the printing process starts only after the end of the data transmission and the disconnection from the control device.

A preferred embodiment of the printing device according to the invention provides for the printing device being provided with at least one accumulator or a battery for supplying energy, and that the accumulator is rechargeable via a data interface, in particular. This way, a preferred mobile, in particular wireless use of the printing device is possible, which also supports the free mobility of the printing device during the printing process in an advantageous manner. The preferred USB interface, being the data interface, can provide the charging power for the accumulator in a manner known per se, resulting in a particularly easy operation of the printing device, because for example, the charging of the accumulator and the transmission of data can at least partially occur simultaneously. This way an additional power supply connection to the housing can also be omitted. Preferably the accumulators are of a standard size, for example AA or AAA for a simple and cost-effective replacement.

It is particularly advantageous when for the protection of the inkjet printing head, a preferably ink-tight closing cap is provided during off times. In particular with a movable use of the printing device, during longer pauses between printing processes, such a protective cap can protect the inkjet printing head not only from damage but also effectively from drying up. Furthermore, accidental leaking of ink can be avoided.

In order to allow replacement of a defective inkjet printing head, it is beneficial for the inkjet printing head to be exchangeable and in particular arranged in a housing part detachable from the housing. In this manner, an exchange of various embodiments of inkjet printing heads is possible depending on their purpose for use. For example, the printable amount of ink can be varied by differently sized inkjets or the print resolution by the number of inkjets.

In order to control the data transmitted into the printing device it is advantageous for the printing device to be provided with a display element, on which at least the data stored in the internal memory can be displayed. In particular in a movable use and/or when several printing devices are used with different content in the device memory, such a display element can be advantageous. The display element can show, in addition to the data stored in the internal device memory, for example, also the date and time statements provided by the time piece, in particular permanently.

Here, it can be beneficial for the printing device to be provided with an input device for entering new data and/or changing existing data in the internal device memory. For example a miniaturized keyboard can be provided, to be operated with a stylus or the like, by which at least the sequence of the data blocks can be changed or certain data blocks can be deleted from the device memory. Here, the display of the operating steps can occur, on the one hand, on the display element and, on the other hand, additionally by acoustic signals.

For a secure operation of the printing device it is particularly advantageous for the printing device to be provided with a distance sensor for measuring a distance between the printing device and the print medium. For example, the distance sensor can control the amount of ink ejected through the inkjets or trigger an acoustic and/or optic warning signal when the printing device is not moved within the preferred range of distance of the print medium from the printing device.

During the printing process the printing device can be moved to change a longitudinal extension of a signal sequence to be printed onto the print medium in the direction of printing at different speeds or to create a non-linear progression of the print signal sequence, in particular in an arched shape, wavy, or similar non-linear fashion. This way, the printing range can not only be changed depending on the existing print medium, but in particular prints are possible not creatable by prior printers that print only straight, linear lines. The printing device can therefore be used in many different fields in a very flexible manner.

Additionally, to create cursive signs the printing device or the inkjet printing head is beneficially rotational in reference to the print media around its longitudinal axis extending perpendicular to a direction of printing, in particular around an angle ranging from approximately 0° to approximately 45°.

For creating print in normal reading direction, it is beneficial for the printing device to be mobile in the reading direction of the printed data, in particular from the left to the right. Here, the signs are printed in consecutive lines from the left to the right, as already mentioned.

However, the printing device can also be moved opposite the normal reading direction, in particular from the right to the left, to create mirror-reflected writing. Here, the creation of writings is possible, for example, in which the reading direction extends from the right to the left. Similarly in a travel direction from the top to the bottom writing can be printed with the respective reading direction. The creation of writing upside-down is possible by the printing device being rotated 180° and moved from the right to the left.

It is advantageous for a preferably exchangeable and/or removable stamping device to be provided at the printing device and for the stamping device to be arranged at an end of the housing facing away from the inkjet printer head, in particular. This stamping device may comprise, in addition to the device memory of the printing device, additional defined, predetermined data. This may for example be a user-specific signature, a company sign, or the like. For example, the stamp arrangement can here be arranged at the end of the printing device facing away from the inkjet printer head, in particular be plugged on. In the normal position the stamping device can be plugged on such that a stamping plate points in the direction of the housing of the printing device or is arranged therein and thus is protected. For the stamping process the stamping device can be detached from the printing device, particularly with the help of at least one stamp gripping element, and can be reattached to the printing device in the stamping position, with in this stamping position the stamping plate now being aligned upside-down, facing away from the housing of the printing device. This way the printing device can simply be rotated by approximately 180° and prior or after the printing a stamp image can be created on the print medium.

The stamping device can be removed from the printing device and be replaced by a stamping device, for example having a differently designed stamp arrangement. The stamp arrangement can here also be a personally, user-specific coding element, with it being possible that in case of a stamping device missing from the printing device the printing device being blocked electronically and/or mechanically and no printing can occur. When a stamping device is plugged on the blocking is released and the printing device is operational. Here, it is also possible, in addition to the blockage, also to transmit personal identification data from the stamping device to the printing device, so that only a certain stamping device can unlock a certain corresponding printing device.

An alternative embodiment may provide for the stamping device to be plugged onto the inkjet printing head for stamping. The stamping device can here be removed from its neutral position at the housing side facing away from the inkjet printing head and be plugged onto the inkjet printing head so that no rotation of the printing head is necessary for stamping.

The stamping device is provided with a storage container forming the ink reservoir, arranged preferably above the stamping plate or the like neighboring it, saturated with ink and filled with an absorbent material. The storage container may be provided with small apertures for a refill, into which for example a pipette or the like can be inserted for refilling ink. It is advantageous for the storage container to be provided with a basic corpus made from micro-porous material and largely covered by a sheet, and for the sheet to be provided at the bottom of the storage container with penetrations according to the stamp image, forming the stamping plate. Using this simple design with a thin sheet cover, the basic corpus can practically be used over the entire volume of the storage container for storing ink so that this way even a size or weight reduced design of the entire manual stamping device can be achieved. Due to its low thickness and its high flexibility the sheet hinders the compression of the basic body during the stamping process only a negligible extent.

An alternative embodiment may provide for the ink reservoir to be an inkpad saturated with ink or the like impinging a stamping plate in the neutral position. The inkpad can here be arranged, for example, in a lid, which in the neutral position of the stamping device can be folded over the stamping plate and thus, on the one hand, applies ink onto the stamping plate and, on the other hand, simultaneously provides protection of the stamping plate from damage and contamination.

In the following an exemplary embodiment of the invention is described in greater detail using the drawing. It shows in a partially schematic illustration:

FIG. 1 a lateral, slightly enlarged view of a printing device according to the invention in the printing position, however without the hand holding and guiding it, at the spatial distance according to the invention in reference to a print medium, which can be printed touchlessly with this printing device,

FIG. 2 a view of the printing device diagonally from the bottom with a view of a cover of the inkjet printing head arranged on an exchangeable housing part,

FIG. 3 a partially longitudinal cross-sectional view of the printing device,

FIG. 4 a perspective view of a stamping device removed from the printing device,

FIG. 5 a cross-sectional view of the stamping device in the neutral position at the end of the printing device facing away from the inkjet printing head, and

FIG. 6 a cross-sectional view of the stamping device in the stamping position at the end of the printing device facing away from the inkjet printing head.

A printing device, in its entirety marked 1 and discernible in FIGS. 1 through 3, has a housing 2 and an inkjet printing head 3 (FIG. 3), which is arranged in the housing 2 fixed or non-adjustable in reference thereto. At the housing 2 a gripping area 4 is provided for a user manually holding it, in order to allow the printing device 1 to be moved in the direction of printing for printing the data stored electronically in the internal memory to a print area mobile in reference thereto, so that during printing the inkjet printing head 3 is displaced together with the printing device 1 in the direction of printing.

The gripping area 4 is here formed by the exterior of the housing 1, as shown in FIG. 1. the housing 1 preferably has dimensions from approximately 15 to 20 centimeters, for example 17 centimeters in length, approximately 2 to 5 centimeters, for example 3 centimeters in width, and approximately 2 to 5 centimeters, for example 3 centimeters in depth, thus the housing 1 can easily be held with one hand and can practically be moved like a writing pen. This is advantageous, in particular, for easily and quickly learning the operation of the printing device 1 in order to give the user a writing feeling as realistic as possible. Here, smaller dimensions of the housing are also possible in order to assimilate the exterior shape of the printing device 1 even more to that of a writing pen. As discernible in the figures, the gripping area 4 is largely smooth, embodied without any larger uneven sections or protrusions, in order to facilitate even an extended manual holding of the printing device 1.

In order to start and finish the printing process, an acceleration and/or speed sensor is provided, not shown in greater detail, and/or as discernible from FIG. 1, a manually operated scanner 5 is arranged at the exterior of the housing 2. The scanner 5 is here advantageously operated by one finger, preferably the index finger of the hand holding the housing 2. This way the printing device 1 can be moved with the desired advancement speed over a print medium 100, and during said movement the scanner 5 can be operated so that particularly during the start of the printing process a printing of images over top of each other due to the advancement speed being too slow can be avoided.

A data interface 6 is provided for transmitting electronic print data from a PC or a similar control device to the internal device memory of the printing device 1. The data interface 6 can here be either embodied as a plug connection for a cable, for example via USB, or wireless in form of a radio or infrared connection. In the preferred embodiment shown in FIG. 1, the data interface 6 is a USB interface. The printing device 1 is provided with batteries or accumulators 7 as an internal power supply, in particular for a mobile use, discernible in FIG. 3 and advantageously being rechargeable via a recharging current from the USB interface 6 while coupled to the PC. The batteries 7 are held in the receptacle 10 known per se.

In FIG. 3, neighboring the two batteries 7, a circuit board 13 of the internal electronics of the printing device 1 is discernible in a schematic illustration, on which in addition to the on/off switch 28 and the data interface 6 the internal device memory, not shown in greater detail, is arranged as well as a control device, not shown in greater detail.

In FIGS. 1 and 3, the on/off switch 28 is discernible, which is embodied as a slide switch arranged at the exterior of the housing 2 and switching on/off the power supply of the printing device. This way, when the printing device 1 is not in use, all electronics can be switched off in order to extend the life of the batteries 7 by this energy saving measure.

An operating light 8 is provided at the exterior of the housing 2, which is discernible in FIGS. 1 and 2, and which can also indicate in addition to the operational state, for example, the charging state or similar operating parameters of the printing device 1, for example by blinking differently and/or different signal colors.

In FIGS. 1 through 3 it is discernible that the inkjet printing head 3 is arranged in a housing part 9 that is detachable from the housing 2. In this manner, the inkjet printing head 3 is exchangeable, which allows an easy replacement in case of a defect or an exchange of the type of inkjet printing head. The housing part 9 is held to the housing 2 via a snap connection, formed by two opposite snapping latches 11 arranged at the housing 2, which in the assembled state of the inkjet printing head 3 are each engaged with a snapping latch 12 at the housing part 9.

According to FIG. 2, a covering closing cap 27 is plugged onto the inkjet printing head 3, which can protect the inkjet printing head 3 from damage and primarily from an unintended ink emission when the printing device 1 is not in use. The closing cap 27 can be detached or folded away with the help of a hinge, not shown in greater detail, in order to uncover the inkjet printing head 3 in the printing position.

For a simplified operation and an improved ergonomic condition of the printing device 1 it is advantageous when, as indicated in FIGS. 1 and 3, the housing part 9 with the inkjet printing head 3 is arranged at a slight angle in reference to the housing 2. Thus the printing device 1, similar to a writing pen, can be held at an angle smaller than 90°, however, the inkjet of the inkjet printing head 3 are preferably positioned perpendicular in reference to the print medium 100. The longitudinal axis of the housing part 9 can here be preferably 5° to 15° in reference to the longitudinal axis of the housing 2.

In order to apply images, symbols, or the like, in particular those larger than one line height of the inkjet printing head 3 or impossible to be processed by the internal electronic of the printing head 1, a stamping device 14 is provided on the printing device 1, which is discernible in FIGS. 1 and 3 at the printing device 1. The stamping device 14 is detachable from the printing device 1 and, at least in the normal position, arranged at the end of the printing device 1 facing away from the inkjet printing head 3.s

The stamping device 14 is provided with two stamp holding elements 15 discernible in FIGS. 1, 3, 4, 5, and 6, by which the stamp device 14 can be detached from the receptacle 16 at the stamping end 18 of the printing device 1 facing away from the inkjet printing head 3, rotated by approximately 180°, and in this stamping position it can be plugged back into said receptacle 16. FIG. 5 shows in a cross-section the normal position of the stamping device 14 with a stamping plate 17 facing inwardly in reference to the housing 2 of the printing device 1, FIG. 6 however shows the stamping position of the stamping device 14 at the stamping end 18 of the printing device 1 with the stamping plate 17 facing outwardly, away from the stamping end 18 of the printing device 1. In the stamping position the printing device 1 is rotated by 180° in reference to the printing position for stamping, and the printing plate 17 with the stamping image 26, arranged at the stamping end 18, is pressed onto the print medium 100.

As discernible from FIGS. 5 and 6, the stamping device 14 is provided with at least two stamp snapping latches 24 for a detachable fastening at the housing 2, each of which engage a housing snapping latch 25 of the housing 2. Here, the stamp snapping latches 24 and the housing snapping latches 25 each are embodied symmetrically such that a detachable fastening is given in the normal position and also in the stamping position of the stamp device 14.

The stamping device 14 is provided, as discernible in FIGS. 5 and 6, with a storage device 19 made from a saturated absorbent material filled with ink as an ink reservoir, arranged in the normal position on top of the stamping plate 17. The storage device 19 has a basic body 21 made from a micro-porous material enwrapped by a sheet 20, which at its upper side 22 has apertures 23 according to the stamp image 26 and thus forms the stamping plate 17.

A printing device 1 with a housing 2 and an inkjet printing head 3 arranged therein serves to print data to a print area, for example electronically stored in an internal data memory. The inkjet printing head 3 is mobile in reference thereto in a direction of printing and arranged in the housing 2 fixed or non-adjustable in reference thereto so that no separate drive is necessary for its advancement. The housing 2 is provided with a gripping area 4 to be held manually by a user and at least in the direction of printing it is freely mobile for creating the advancement during printing.

1. A printing device (1) comprising a housing (2) and an inkjet printing head (3) arranged therein, which is movable in reference thereto for printing data stored electronically in an internal device memory, with the inkjet printing head (3) in the housing (2) being arranged fixed or non-adjustable in reference thereto and the housing (2) having a gripping area (4) to be manually held by a user, the printing device (1) with the housing (2) is freely movable at least in a printing direction and a spatial distance of the printing device (1) from a print medium (100) can be freely selected and the print medium (100) can be printed in a contact-free operation.

2. A printing device according to claim 1, wherein at least a part of an exterior of the housing (2) is provided with or forms the gripping area (4) and the housing (2) can be at least partially held by hand.

3. A printing device according to claim 1, wherein a handle is provided on the housing (2) as the gripping area (4).

4. A printing device according to claim 1, wherein the ink can be printed on the print medium (100) outside the housing (2).

5. A printing device according to claim 1, wherein the distance between the printing device (1) and the print medium (100) can vary from approximately half a millimeter to approximately half a centimeter.

6. A printing device according to claim 1, further comprising at least one of an acceleration or speed sensor that detects a change of speed to at least one of start or stop the printing process.

7. A printing device according to claim 1, further comprising a manually operated sensor (5) on the exterior of the housing (2) to at least one of start or stop the printing process.

8. A printing device according to claim 1, wherein for controlling a line width or an image distance, a programmable clock generator is provided to create a pulse, with a number of pulses being equivalent to a number of printing gaps of the data to be printed.

9. A printing device according to claim 1, wherein printing device (1) is provided with a data interface (6) to be coupled to a PC or a control device.

10. A printing device according to claim 9, wherein the data can be transmitted between the data interface (6) of the printing device (1) and the PC using a data transmission wire or wireless data transmission.

11. A printing device according to claim 9, wherein the printing device (1) is provided with at least one accumulator (7) or a battery as a power supply and the accumulator can be recharged via the data interface (6).

12. A printing device according to claim 1, wherein an ink-tight closing cap (27) is provided to protect the inkjet printing head(s) when not in use.

13. A printing device according to claim 1, wherein the inkjet printing head (3) can be exchanged and is arranged in a housing part (9) detachable from the housing (2).

14. A printing device according to claim 1, wherein the printing device (1) is provided with a display element, on which at least data stored in an internal device memory can be displayed.

15. A printing device according to claim 14, wherein the printing device (1) has an input device for at least one of entering new data or changing existing data in the internal device memory.

16. A printing device according to claim 1, wherein the data to be printed represents consecutive data blocks, each of the data blocks comprises at least one of predetermined data or freely defined data, and the data represents at least one of letters or symbols.

17. A printing device according to claim 1, wherein the printing device (1) is provided with a distance sensor for measuring the distance between the printing device and the print medium (100).

18. A printing device according to claim 1, wherein the printing device (1) can quickly be moved to change a longitudinal extension of an image sequence to be printed on a print medium (100) in the direction of printing.

19. A printing device according to claim 1, wherein the printing device (1) is movable to create a non-linear line progression of a printed image sequence.

20. A printing device according to claim 1, wherein the printing device (1) or the inkjet printing head (3) is rotatable around a longitudinal axis thereof, extending perpendicular in reference to the direction of printing.

21. A printing device according to claim 1, wherein the printing device (1) is movable from the left to the right in a reading direction of the printed data.

22. A printing device according to claim 1, wherein the printing device (1) is movable opposite a normal reading direction from the right to the left, to create mirror-reflected writing.

23. A printing device according to claim 1, wherein a stamping arrangement (14) is provided on the printing device (1), that is at least one of exchangeable or detachable, and the stamp device (14) is arranged at an end of the housing (2) facing away from the inkjet printing head (3).

24. A printing device according to claim 23, wherein the stamping device (14) can be plugged onto the inkjet printing head (3) for stamping.

25. A printing device according to claim 23, wherein the stamping device (14) is provided with a storage container (19) filled with an absorbent material saturated with ink serving as an ink reservoir, adjacent to a stamping plate (17).

26. A printing device according to claim 25, wherein the ink reservoir is an inkpad saturated with ink impinging the stamping plate (17) in a normal position.

27. A printing device according to claim 1, wherein the printing device (1) is provided with an internal time piece located in the printing device (1).
